(19) United States
(12) Patent Application Publication
(10) Pub. No.: US 2006/0153050 A1
(43) Pub. Date: Jul. 13, 2006

(54) Multi stack optical data storage medium and use of such medium

(75) Inventor: Andrei Mijiritskii, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Eindhoven (NL)

(21) Appl. No.: 10/561,859

(22) PCT Filed: Jun. 28, 2004
(86) PCT No.: PCT/IB04/51027

§ 371 Date: Dec. 21, 2005

(30) Foreign Application Priority Data
Jul. 3, 2003 (EP) 03101993.8

(51) Int. Cl. G11B 7/24

(52) U.S. Cl. 369/275.1; 369/283

(57) ABSTRACT

A multi stack optical data storage medium (15) for recording and reading by means of a focused radiation beam (10) is described. The beam enters the medium (15) through a first entrance face (11), and has at least a first substrate (1) with on at least one side thereof: a first layer stack (2), comprising a first information layer, a second layer stack (4), comprising a second information layer. The second layer stack is present at a position closer to the first entrance face (11) than the first layer stack (2), and is separated from the first layer stack by a first transparent spacer layer (3). The first and the second layer stack each have an effective radiation beam reflection Rₑ if between 0.04 and 0.08 according to the Blu-ray Disc (BD) standard specification. A third layer stack (6), comprising a third information layer, is present at a position closest to the first entrance face (11), and is separated from the second layer stack (4) by a second transparent spacer layer (5). The third layer stack has a radiation beam transmission T₃ larger than 0.70, and the third information layer is a read only layer or a write once layer. A multi stack optical data storage medium is achieved which has increased data capacity and which has reflection values compatible with the dual stack BD standard specification.

The invention relates to a multi stack optical data storage medium for recording and reading by means of a focused radiation beam entering the medium through a first entrance face, said medium having at least a first substrate with on at least one side thereof:

a first layer stack, comprising a first information layer,

a second layer stack, comprising a second information layer, said second layer stack being present at a position closer to the first entrance face than the first layer stack, separated from the first layer stack by a first transparent spacer layer,

the first and the second layer stack each having an effective radiation beam reflection between 0.04 and 0.08.

The invention further relates to the use of such a medium in a device suitable for recording and reading a dual stack optical data storage medium by means of a focused radiation beam.

An optical data storage medium as described in the opening paragraph is known as the Blu-ray Disc (BD).

This new format of optical data storage medium has been introduced recently and has an extended storage capacity and data rate compared to the Digital Versatile Disc (DVD) format. The BD uses a blue, i.e. approximately 405 nm, radiation beam wavelength and a relatively high numerical aperture (NA) of the focused radiation beam. For this format read only (ROM), write once (R) and rewritable (RW) versions have been or will be introduced.

A dual-stack BD medium exists in which medium two information stacks are present separated by a transparent spacer layer of about 25 μm thickness. Thus the capacity of the medium is doubled compared to the single stack version. According to the BD standard specification, the effective reflection of each stack should be between 0.04 and 0.08 at a radiation beam wavelength of approximately 405 nm. It is generally recognized that addition of one or more stacks to the double stack medium adversely affects the effective reflection level of each layer. For example the phase change materials used as a rewritable layer in the stacks exhibit low transmission and reflection values at the radiation beam wavelength which makes addition of an extra stack and compliance to the reflection values of the standard impossible. However, it can be foreseen that higher capacity media will be in demand.

It is an object of the invention to provide a multi stack optical data storage medium of the type mentioned in the opening paragraph which has increased data capacity and which has reflection values compatible with the dual stack BD standard specification.

This object is achieved by the multi stack optical data storage medium according to the invention in that a third layer stack, comprising a third information layer, is present at a position closest to the first entrance face, separated from the second layer stack by a second transparent spacer layer, and said third layer stack having a radiation beam transmission T₃ larger than 0.70, and the third information layer is of a type selected from the group of types consisting of a read only layer and a write once layer.

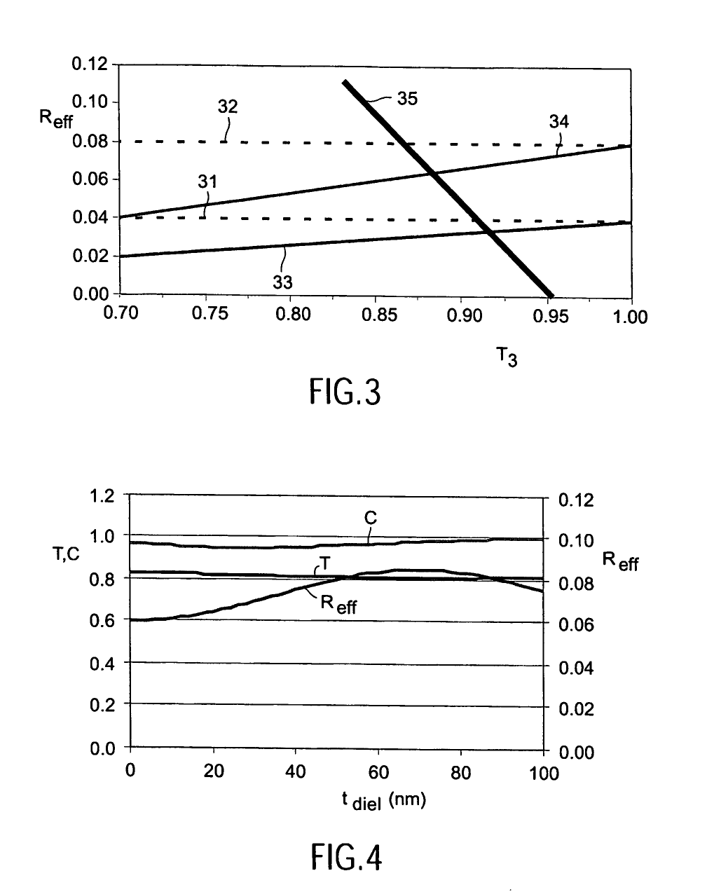

Applicant has recognized that a read only stack or a write once stack can be safely added to a dual-layer BD disc without substantially altering the optical and thermal properties of the first and second layer stack. According to the BD standard, the effective reflection of both the first and the second layer stack of a dual-stack disc should be between 0.04 and 0.08. If a third layer stack is added to such a dual-stack disc, so that the third layer stack is situated between the second layer stack and the entrance face of e.g. a disc cover, than depending on the transmission of the third layer stack the boundaries of the effective reflection of the first and the second layer stack shift as indicated in e.g. FIG. 3 with solid lines 33 and 34. As can be seen, in the 0.70-1.00 transmission range of the third layer stack the effective reflection of the first and the second layer stacks may still stay within the reflection range defined by the Blu-ray Disc specification (v. 1.0). It is advantageous when the radiation beam transmission T₃ is larger than 0.75, 0.80 or even 0.85 in which cases a broader reflection range of the first and second layer stack between 0.04 and a value between 0.04 and 0.08 is possible.

In an embodiment at least one of the first and the second information layer is a rewritable layer. There are some capacity-demanding applications which deal with vast amounts of information only a part of which would need to be changed. Examples of such applications are home video editing, studio remakes, adding extra features such as “bookmarks”, video-games etc. Also, applications of data storage media with zones containing information that is not allowed for user editing are known. Therefore a third stack according to the invention is very useful while backwards compatibility with the dual stack medium is guaranteed. Such a tri stack medium is usable in a recorder/player which is suitable for dual-stack BD media. However such a recorder will only be able to record and read the first and the second layer stack but with reflection values which are fully within the dual stack BD specification. For accessing the third layer stack a modification of the recorder/player is required. In an advantageous case this modification may be limited to the firmware of the recorder/player, which modification may be performed by an end user.

It is advantageous when a reflective layer comprising a dielectric material is present adjacent the third information layer. A high transmission value combined with a proper reflection value can be achieved with such a material.

In another embodiment the third information layer is a read only layer and the third layer stack has a radiation beam transmission between 0.86 and 0.91. As can be seen from FIG. 2 a third stack is possible with a transmission which varies in the 0.83-0.95 range depending on the thickness of e.g. a dielectric reflective layer of (ZnS)₈₀(SiO₂)₂₀. When using only the range between 0.86 and 0.91 a tri stack BD medium is achieved where the effective reflections of all the stacks in the medium fall within the 0.04-0.08 range.

In a further embodiment the third information layer is a write-once layer and the third layer stack has a radiation beam transmission between 0.81 and 0.84. As can be seen from FIG. 4 a third stack is possible with a transmission which varies in the 0.80-0.84 range depending on the thickness of e.g. a dielectric reflective layer of SiO₂. When using only the range between 0.81 and 0.84 a tri stack BD medium may be achieved where the effective reflections of all the stacks in the medium fall within the 0.04-0.08 range.

In a dual sided embodiment of the optical data storage medium a second radiation beam entrance face opposite to the first entrance face is present for recording and reading by means of a focused radiation beam, entering the medium through the second entrance face, in a fourth, fifth and sixth stack identical to the respectively the first, second and third stack. This embodiment has the advantage of a doubled capacity compared to the single sided embodiments described earlier.

The maximum data capacity of a single-sided dual-stack optical data storage medium is limited, e.g. to 54 GB for BD if conventional optical recording principles are employed. In order to store two versions of a high definition movie in BD format, including extra features, on one disc, e.g. a full-screen and wide-screen version as is commonly done for movies distributed in the U.S., 54 GB of storage capacity may be insufficient. Therefore a compatible single-sided triple-stack optical recording medium is proposed, which enhances the capacity with another 50%, i.e. 81 GB. In a compatible double-sided triple-stack embodiment of the optical recording medium this capacity is again doubled to 162 GB.

As said before, for an optical data storage medium compatible with the dual stack BD specification the effective reflection level of the stacks ranges from 0.04 to 0.08 at a radiation beam wavelength of approximately 405 nm. However, another wavelength may be used for future formats.

The invention will be elucidated in greater detail with reference to the accompanying drawings, in which

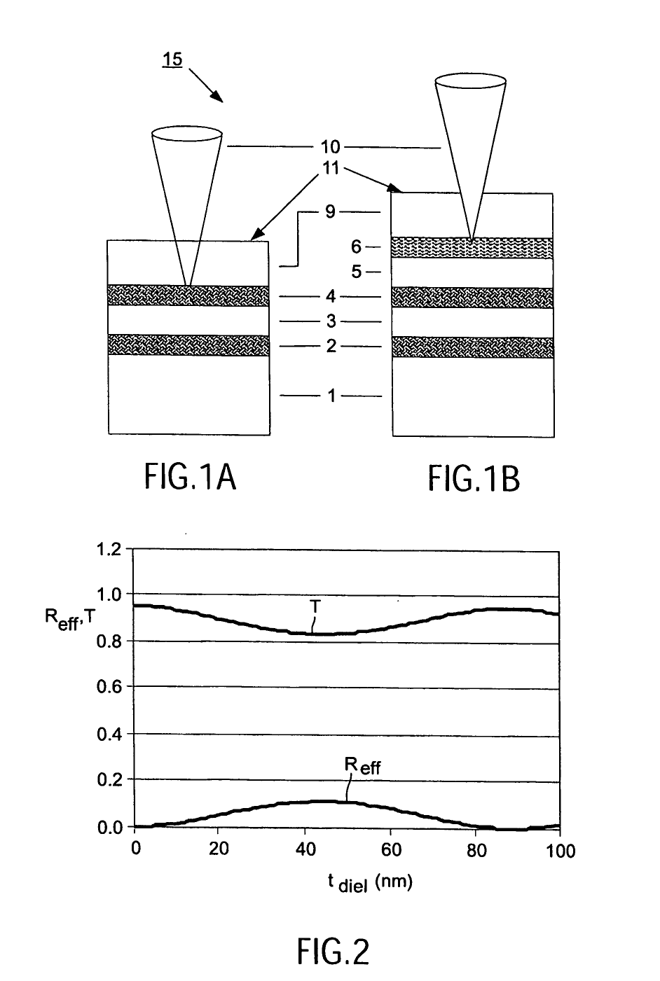

FIG. 1A shows a dual-stack BD-RW medium and FIG. 1B shows a tri-stack BD-R(OM)/RW medium,

FIG. 2 shows the optical parameters effective reflection R_{eff} and transmission T of a BD-ROM stack as a function of the thickness t_{diel} of a dielectric mirror in said stack made of (ZnS)₈₀(SiO₂)₂₀,

FIG. 3 shows the effective reflection boundaries versus transmission T₃ of the third (BD-ROM) stack. The dashed lines 31 and 32 indicate the allowed effective reflection boundaries of a dual-layer BD medium in accordance with the Blu-ray Disc standard v.1.0. The solid lines 33 and 34 show the shift in the reflection boundaries caused by adding a BD-ROM stack to the BD-medium as depicted in FIG. 1B. The solid line 35 represents the possible calculated solutions of the effective reflection of the third BD-ROM stack,

FIG. 4 shows optical parameters effective reflection R_{eff}, transmission T and contrast C of a dye based BD-R stack as a function of the thickness t_{diel} of a dielectric mirror made of SiO₂ in said stack,

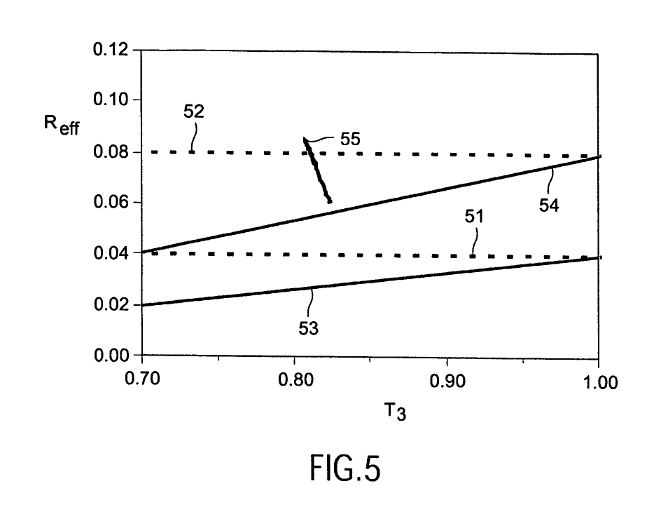

FIG. 5 shows the effective reflection boundaries versus transmission of the third (BD-R) stack. The dashed lines 51 and 52 indicate the allowed effective reflection boundaries of a dual-layer BD medium in accordance with the Blu-ray Disc standard v.1.0. The solid lines 53 and 54 show the shift in the reflection boundaries caused by adding a BD-ROM stack to the BD-medium as depicted in FIG. 1b. The solid line 55 represents the possible calculated solutions of the effective reflection of the third (BD-R) stack.

In FIG. 1A a known BD multi stack optical data storage medium 15, i.e. a disc, for recording and reading by means of a focused radiation beam 10 is shown. The radiation beam 10 enters the medium 15 through a first radiation beam entrance face 11. The medium has at least a first substrate 1 with on at least one side of the first substrate 1 a first layer stack 2, comprising a first information layer, a second layer stack 4, comprising a second information layer. The second layer stack 4 is present at a position closer to the first radiation beam entrance face than the first layer stack 2. The second layer stack is separated from the first layer stack by a first transparent spacer layer 3. The first information layer and the second information layer are rewritable layers. The first and the second layer stack each have an effective radiation beam reflection between 0.04 and 0.08.

In FIG. 1B, according to the invention, a third layer stack 6, comprising a third information layer, is present at a position closest to the first entrance face. The first and second layer stacks are identical to the stacks described under FIG. 1A. The third layer stack is separated from the second layer stack by a second transparent spacer layer 5, and has a radiation beam transmission larger than 0.70. The third information layer is of a type selected from the group of types consisting of a read only layer and a write once layer. The embodiment of FIG. 1B will now be discussed in more detail.

Substrate 1 has a servo pregroove or guide groove pattern in its surface at the side of the first layer stack 2 and is made of polycarbonate (n=1.6) and has a thickness of 1.1 mm. The servo pregroove is used for guiding the focused radiation beam 10 during recording and/or read out. First layer stack 2 is a rewritable stack, which comprises, in this order, a first dielectric layer made of (ZnS)₈₀(SiO₂)₂₀ (n=2.3) having a thickness of 43 nm and deposited by sputtering, a rewritable recording layer made of a phase-change GeInSbTe alloy having a thickness of 11 nm and deposited by sputtering, a second dielectric layer made of (ZnS)₈₀(SiO₂)₂₀ (n=2.3) having a thickness of 9 nm and deposited by sputtering, a reflective layer made of Ag having a thickness of 120 nm and deposited by sputtering. The laser beam enters the rewritable stack 2 from the side of the first dielectric layer, which is opposite to the stack side adjacent to the disc substrate 1. The first transparent spacer layer 3 is made of an UV-curable resin or a pressure-sensitive adhesive (PSA) with a thickness in the range of 20-30 μm, in this case 25 μm. The second layer stack 4 comprises, in this order, a first dielectric layer made of (ZnS)₈₀(SiO₂)₂₀ having a thickness of 42 nm and deposited by sputtering, a rewritable recording layer made of a phase-change GeInSbTe alloy (crystalline: n=1.5; k=3.45) having a thickness of 6 nm and deposited by sputtering, a second dielectric layer made of (ZnS)₈₀(SiO₂)₂₀ having a thickness of 9 nm and deposited by sputtering, a semi transparent reflective layer made of Ag having a thickness of 10 nm and deposited by sputtering, and a third dielectric layer made of (ZnS)₈₀(SiO₂)₂₀ having a thickness of 25 nm and deposited by sputtering. The laser beam enters the rewritable stack 4 from the side of the first dielectric layer, which is opposite to the stack side adjacent to the first transparent spacer layer 3. The spacer layer 3 has a servo pregroove or guide groove pattern in its surface at the side of the second layer stack 4.

The third layer stack comprises a dielectric reflective layer made of (ZnS)₈₀(SiO₂)₂₀ with a thickness of 27 nm adjacent the third information layer, which in this case comprises a plurality of embossed pits in the surface of spacer layer 5.

The listed optical parameters n and k are for λ=405 nm which is the radiation beam wavelength. The calculated effective reflections and transmissions are:

First Layer Stack 2 and Second Layer Stack 4:

The effective reflection of both layers is in full compliance with the BD-standard: 0.04<R_{eff}<0.08.

Third Layer Stack 6:

Effective Reflection (R_{eff})=0.078

Transmission T₃=0.869

Alternatively the third layer stack 6 may comprise a write once third information layer made of e.g. a cyanine dye, azo dye, sensitive to the radiation beam wavelength, having an appropriate thickness e.g. of about 40-80 nm between grooves. The dye may be deposited by e.g. spincoating. A dielectric reflective layer made of SiO₂ having a thickness of e.g. 38 nm is present adjacent the third information layer at a side of the spacer layer 5 and may be deposited by e.g. sputtering. The spacer layer 5 has a servo pregroove or guide groove pattern in its surface at the side of the third layer stack 6. For this embodiment the following reflection and transmission values are achieved for the third layer stack:

Third Layer Stack 6:

Effective Reflection (R_{eff})=0.0737

Transmission T₃=0.8146

In FIG. 2 the calculated optical parameters effective reflection R_{eff} and transmission T of a BD-ROM stack with a dielectric reflective layer are shown as a function of the dielectric reflective layer thickness t_{diel}. The dielectric layer is made of (ZnS)₈₀(SiO₂)₂₀. A BD-ROM stack can be made by replicating or embossing pits in a layer of plastic (the layer can be a disc substrate or a spacer layer of a multi-layer disc or the like) and adding e.g. a dielectric mirror to obtain sufficient reflection. As can be seen from the figure, the transmission T of such a stack varies in the 0.83-0.95 range. According to the Blu-ray Disc (BD) standard specification, the effective reflection of both the first and the second layer stack of a dual-stack disc should be between 0.04 and 0.08. This range is indicated in FIG. 3 with dashed lines 31 and 32 respectively. If a third BD-ROM stack is added to such a dual-stack disc, situated between the second stack and the disc cover 9 (see FIG. 1B), than depending on the transmission of the third ROM stack the boundaries of the effective reflection of the first and second stack shift as indicated in FIG. 3 with solid lines 33 and 34. As can be seen, in the 70%-100% transmission range of the third stack the effective reflection of the first and second stacks can still stay within the reflection range defined by the Blu-ray Disc standard specification (v. 1.0).

In FIG. 3 the effective reflection R_{eff} boundaries versus transmission T₃ of the third (BD-ROM) stack are shown. The dashed lines 31 and 32 indicate the allowed effective reflection boundaries of a dual-layer BD medium in accordance with the Blu-ray Disc standard v.1.0. The solid lines 33 and 34 show the shift in the reflection boundaries caused by adding a BD-ROM stack to the BD-medium as depicted in FIG. 1B. The solid line 35 represents possible solutions for the effective reflection R_{eff} of the third BD-ROM stack as a function of its transmission T₃. As can be seen from this plot, the reflection of the BD-ROM stack can be made such that it falls within the 0.04-0.08 range. Thus, in this embodiment it is shown that a tri-stack BD can be made where the first and second layer stacks are of e.g. the rewritable type and the third layer stack is of read-only type. Moreover, it demonstrated that R_{eff} of all the stacks in the disc falls within the 0.04-0.08 range.

In FIG. 4 the calculated optical parameters effective reflection R_{eff}, transmission T and optical contrast C of a BD-R stack with a dielectric reflective layer are shown as a function of the dielectric reflective layer thickness t_{diel}. The dielectric layer is made of SiO₂. As can be seen from the figure, the transmission T of such a stack varies in the 0.80-0.84 range. According to the Blu-ray Disc (BD) standard, the effective reflection of both the first and the second layer stack of a dual-stack disc should be between 0.04 and 0.08. This range is indicated in FIG. 5 with dashed lines 51 and 52 respectively. If a third BD-R stack is added to such a dual-stack disc, situated between the second stack and the disc cover 9 (see FIG. 1B), than depending on the transmission of the third BD-R stack the boundaries of the effective reflection of the first and second stack shift as indicated in FIG. 5 with solid lines 53 and 54. As can be seen, in the 0.70-1.00 transmission range of the third stack the effective reflection of the first and second stacks can still stay within the reflection range defined by the Blu-ray Disc standard specification (v. 1.0).

In FIG. 5 the effective reflection R_{eff} boundaries versus transmission T₃ of the third (BD-R) stack are shown. The dashed lines 51 and 52 indicate the allowed effective reflection boundaries of a dual-layer BD medium in accordance with the Blu-ray Disc standard v.1.0. The solid lines 53 and 54 show the shift in the reflection boundaries caused by adding a third BD-R stack 6 to the BD-medium as depicted in FIG. 1B. The solid line 55 represents possible solutions for the effective reflection R_{eff} of the third (BD-R) stack as a function of its transmission T₃. As can be seen from this plot, the reflection of the BD-R stack can be made such that it falls within the 0.04-0.08 range. Thus, in this embodiment it is shown that a tri-stack Blu-ray disc can be made where the first and second layer stacks are of e.g. the rewritable type and the third stack is of the write-once type. Moreover, it demonstrated that the effective reflections of all the stacks in the disc fall within the 0.04-0.08 range.

It should be noted that the above-mentioned embodiment illustrates rather than limits the invention, and that those skilled in the art will be able to design many alternative embodiments without departing from the scope of the appended claims. In the claims, any reference signs placed between parentheses shall not be construed as limiting the claim. The word “comprising” does not exclude the presence of elements or steps other than those listed in a claim. The word “a” or “an” preceding an element does not exclude the presence of a plurality of such elements. The mere fact that certain measures are recited in mutually different dependent claims does not indicate that a combination of these measures cannot be used to advantage.

According to the invention a multi stack optical data storage medium for recording and reading by means of a focused radiation beam is described. The beam enters the medium through a first entrance face, and has at least a first substrate with on at least one side thereof: a first layer stack, comprising a first information layer, a second layer stack, comprising a second information layer. The second layer stack is present at a position closer to the first entrance face than the first layer stack, and is separated from the first layer stack by a first transparent spacer layer. The first and the second layer stack each have an effective radiation beam reflection R_{eff} between 0.04 and 0.08 according to the Blu-ray Disc (BD) standard specification. A third layer stack, comprising a third information layer, is present at a position closest to the first entrance face, and is separated from the second layer stack by a second transparent spacer layer. The third layer stack has a radiation beam transmission T₃ larger than 0.70, and the third information layer is a read only layer or a write once layer. A multi stack optical data storage medium is achieved which has increased data capacity and which has reflection values compatible with the dual stack BD standard specification.

1. A multi stack optical data storage medium (15) for recording and reading by means of a focused radiation beam (10) entering the medium (15) through a first entrance face (11), said medium having at least a first substrate (1) with on at least one side thereof:
a first layer stack (2), comprising a first information layer,
a second layer stack (4), comprising a second information layer, said second layer stack being present at a position closer to the first entrance face (11) than the first layer stack (2), separated from the first layer stack by a first transparent spacer layer (3),
the first and the second layer stack each having an effective radiation beam reflection Reff between 0.04 and 0.08,
characterized in that a third layer stack (6), comprising a third information layer, is present at a position closest to the first entrance face (11), separated from the second layer stack (4) by a second transparent spacer layer (5), and said third layer stack having a radiation beam transmission T3 larger than 0.70, and the third information layer is of a type selected from the group of types consisting of a read only layer and a write once layer.

2. A multi stack optical data storage medium as claimed in claim 1, wherein at least one of the first and the second information layer is a rewritable layer.

3. A multi stack optical data storage medium as claimed in claim 1, wherein a reflective layer is present adjacent the third information layer comprising a dielectric material.

4. A multi stack optical data storage medium as claimed in claim 1, wherein the third information layer is a read only layer and the third layer stack has a radiation beam transmission T3 between 0.86 and 0.91.

5. A multi stack optical data storage medium as claimed in claim 1, wherein the third information layer is a write-once layer and the third layer stack has a radiation beam transmission T3 between 0.81 and 0.84.

6. A multi stack optical data storage medium as claimed in claim 1, wherein a second radiation beam entrance face opposite to the first entrance face is present for recording and reading by means of a focused radiation beam, entering the medium through the second entrance face, in a fourth, fifth and sixth stack identical to the respectively the first, second and third stack.

7. Use of a multi stack optical data storage medium as claimed in claim 1 in a device suitable for recording and reading a dual stack optical data storage medium by means of a focused radiation beam, in which medium the first and the second layer stack each have an effective radiation beam reflection Reff between 0.04 and 0.08.
